(19) United States
(12) Patent Application Publication
(10) Pub. No.: US 2019/0028530 A1
(43) Pub. Date: Jan. 24, 2019

(54) INFORMATION PROCESSING APPARATUS, METHOD OF CONTROLLING THE SAME, AND COMPUTER READABLE MEDIUM

(71) Applicant: CANON KABUSHIKI KAISHA, Tokyo (JP)

(72) Inventor: Shuichi Okada, Yokohama-shi (JP)

(21) Appl. No.: 16/033,606

(22) Filed: Jul. 12, 2018

(30) Foreign Application Priority Data
Jul. 19, 2017 (JP) 2017-140283

(51) Int. Cl. H04L 29/08

(52) U.S. Cl. CPC H04L 67/02; H04L 67/2814; H04L 67/146

(57) ABSTRACT

In a case where a URL redirect occurs when connecting to a Web server, a URL for connecting to a Web app that the application for Web connection holds is changed automatically to the redirect destination URL.

### BACKGROUND OF THE INVENTION

### Field of the Invention

The present invention relates to an information processing apparatus and a method of controlling the same.

### Description of the Related Art

In recent years, systems in which it is possible to extend a function of a multi function peripheral (MFP), which comprises a scan function and a print function, by installing an application have spread (refer to Japanese Patent Laid-Open No. 2006-40217). Also, among such applications are those that enable user operation by connecting to a Web app server that is connected by a network, and displaying an operation screen of a Web application by a Web browser that the multi function peripheral comprises. To use a Web application on such a multi function peripheral, an application (hereinafter an MFP app for Web connection) for connecting to the Web application may be installed. The MFP app for Web connection holds a URL of a connection destination in advance. When an MFP app for Web connection is started, this URL is connected to, and an operation screen of the Web application is displayed by a Web browser that the multi function peripheral comprises.

In the case of a change (replacement with a new terminal or the like) of the Web app server during operation of the multi function peripheral, the URL of the Web app server may change. In a case in which the URL of the Web application changed, it is necessary to update the URL that the MFP app for Web connection for using the Web application holds. Updating the URL is performed by re-generating the MFP app for Web connection and re-installing it on the multi function peripheral, or changing the MFP app for Web connection settings manually for each device, but that is very cumbersome, and may result in update failure. In this way, synchronization of an access destination such as a URL for using a Web application and an access destination such as a URL that an MFP app for Web connection holds is accompanied by complicated operation, and furthermore there is no guarantee that accurate update will be achieved.

### SUMMARY OF THE INVENTION

The present invention allows for easy and accurate synchronization of a set access destination when there is a change to an access destination of a Web application.

The present invention has the following configuration.

According to one aspect of the present invention, there is provided an information processing apparatus that has a Web browser and a connecting unit for connecting to a server that provides a Web application, the information processing apparatus comprising: at least one processor; and at least one memory in which a program is stored, wherein by the processor executing the program, the information processing apparatus is caused to function as an access unit that, in accordance with an instruction, accesses via the Web browser a registered access destination corresponding to the Web application; and an update unit that, in a case where it is notified from the Web browser that the registered access destination is redirected to a new access destination, updates the registered access destination with the new access destination.

By virtue of the present invention, easy and accurate synchronization of a set access destination is possible when there is a change to an access destination of a Web application.

Further features of the present invention will become apparent from the following description of exemplary embodiments (with reference to the attached drawings).

### BRIEF DESCRIPTION OF THE DRAWINGS

FIG. 1 is a view illustrating an overall configuration of an information processing system according to embodiments of the present invention.

FIG. 2 is a block diagram for describing a hardware configuration of an MFP according to embodiments.

FIG. 3 is a block diagram for describing a hardware configuration of a Web app server according to embodiments.

FIG. 4 is a view illustrating a configuration of applications and software modules of the MFP according to embodiments.

FIG. 5 is a view illustrating a configuration of a software module of an MFP app for Web connection according to embodiments.

FIG. 6 is a view illustrating an example of a manifest file of an MFP app for Web connection according to embodiments.

FIG. 7 is a view illustrating a configuration of software modules of the Web app server the according to embodiments.

FIG. 8 is a flowchart illustrating an example of processing in the MFP according to embodiments.

FIG. 9 is a view illustrating an example of a GUI that is displayed on an operating unit of the MFP according to embodiments.

FIG. 10 is a sequence diagram illustrating an example of processing in the information processing system according to embodiments of the present invention.

FIG. 11 is a flowchart illustrating an example of processing in the MFP according to embodiments.

FIG. 12 is a sequence diagram illustrating an example of processing in the MFP according to embodiments.

FIGS. 13A and 13B are flowcharts illustrating an example of processing in the MFP according to embodiments.

FIG. 14 is a sequence diagram illustrating an example of processing in the MFP according to embodiments.

FIG. 15 is a view illustrating an example of a GUI that is displayed on the Web browser according to embodiments.

### DESCRIPTION OF THE EMBODIMENTS

Embodiments of the present invention will be described hereinafter in detail, with reference to the accompanying drawings. Note that the following embodiments do not limit the present invention in accordance with the scope of the patent claims, and, in addition, not all combinations of the features explained in the embodiments are necessarily required in the units in the present invention solution. In the embodiment, applications are defined as follows. An application of a type that is provided from a Web app server connected to by a network is referred to as a Web application (hereinafter, a Web app). An operation screen of a Web app is displayed using a Web browser that the multi function peripheral comprises. Meanwhile, an application of a type that is installed on the multi function peripheral is referred to as an MFP application (hereinafter MFP app). An installed MFP app is stored as data in the multi function peripheral.

### First Embodiment

System Configuration

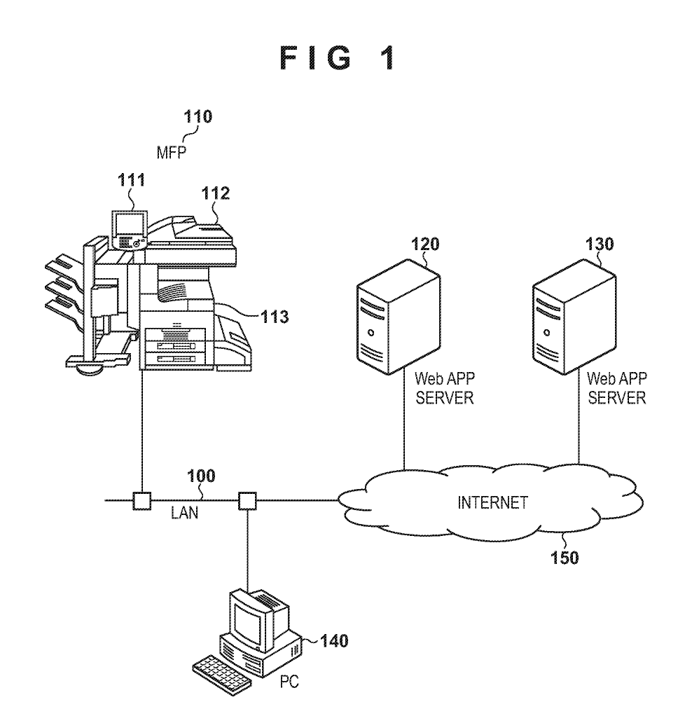

FIG. 1 is a view illustrating an overall configuration of an information processing system according to an embodiment of the present invention. In this information processing system, an MFP 110 and a PC 140 are connected via a LAN 100, and the LAN 100 is connected to the Internet 150. Additionally, a Web application server 120 and a Web application server 130 are connected to the Internet 150.

The MFP 110 is an MFP (multi function peripheral) that has an operating unit 111, a scanner unit 112, and a printer unit 113. The MFP 110 according to the embodiment functions as a client terminal for displaying and operating operation screens of a Web app by using a built-in Web browser. Also, in accordance with an instruction of a Web app, the MFP 110 can print an image that was obtained from a Web app by using the printer unit 113, and can transmit to a Web app image data obtained by scanning an original by using the scanner unit 112. Note that an identifier called a device ID is assigned to the MFP according to this embodiment, and it is possible to uniquely identify and recognize each MFP by this identifier.

The Web application server 120 is a server that executes a Web app. The Web application server 130 is a server for moving operation of the Web app from the Web application server 120 for reasons of upgrading the OS or the like. Note that the Web application server 130 need not be on the present system configuration in advance, and may be constructed at the time of movement of the Web app server in the future. The PC 140 functions as a terminal apparatus for performing various settings in relation to the MFP 110. However the foregoing system configuration is only one example, and the number of devices and the like is not limited to the embodiment.

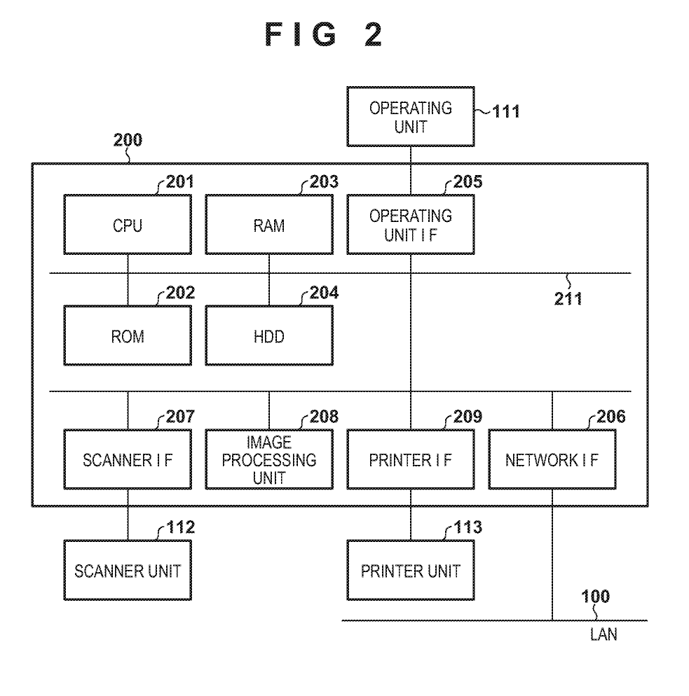

FIG. 2 is a block diagram for describing a hardware configuration of the MFP 110 according to the embodiment. The operating unit 111 has a display unit with a touch panel function and various hardware keys, displays information to a user in accordance with data from a control unit 200, and inputs to the control unit 200 information according to an operation of a user. The operating unit 111 functions as a user interface (UI) device. The scanner unit 112 scans an image of an original, generates image data of that image, and supplies that to the control unit 200. The printer unit 113 prints an image onto a sheet based on image data received from the control unit 200.

The control unit 200 is connected electrically to the operating unit 111, the scanner unit 112, and the printer unit 113, and is connected via a network interface (I/F) 206 to the LAN 100 also. With this, communication is possible by a communication protocol such as TCP/IP via the LAN 100. In the control unit 200, a CPU 201, a ROM 202, a RAM 203, an HDD 204, an operation unit I/F 205, the network I/F 206, a scanner I/F 207, an image processing unit 208, and a printer I/F 209 are connected via a system bus 211. The CPU 201 executes a boot program in the ROM 202, loads an OS and control programs that are stored in the HDD 204 into the RAM 203, and comprehensively controls the MFP 110 based on such programs. This control includes execution of programs for realizing later-described flowcharts. In the ROM 202, the boot program and various data of the MFP 110 is stored. The RAM 203 provides a work memory for the CPU 201 to operate, and provides an image memory to temporarily store inputted image data. The HDD 204 is a hard disk drive, and stores an OS, various programs, and image data. The operation unit I/F 205 is an interface unit for connecting the system bus 211 and the operating unit 111. The network I/F 206 connects to the LAN 100 and the system bus 211, and inputs and outputs information via a network. The scanner I/F 207 controls an interface between the scanner unit 112 and the control unit 200. The image processing unit 208 performs image processing such as rotation, color conversion, and image compression/decompression processing with respect to image data input from the scanner unit 112 and image data output to the printer unit 113. The printer I/F 209 receives image data processed by the image processing unit 208, and controls printing by the printer unit 113 in accordance with attribute data attached to the image data. Note that the operating unit 111 is described using an example of an MFP that can display a UI in the embodiment, but configuration may be taken to use an information processing apparatus such as a general-purpose computer, for example, in place of the MFP 110.

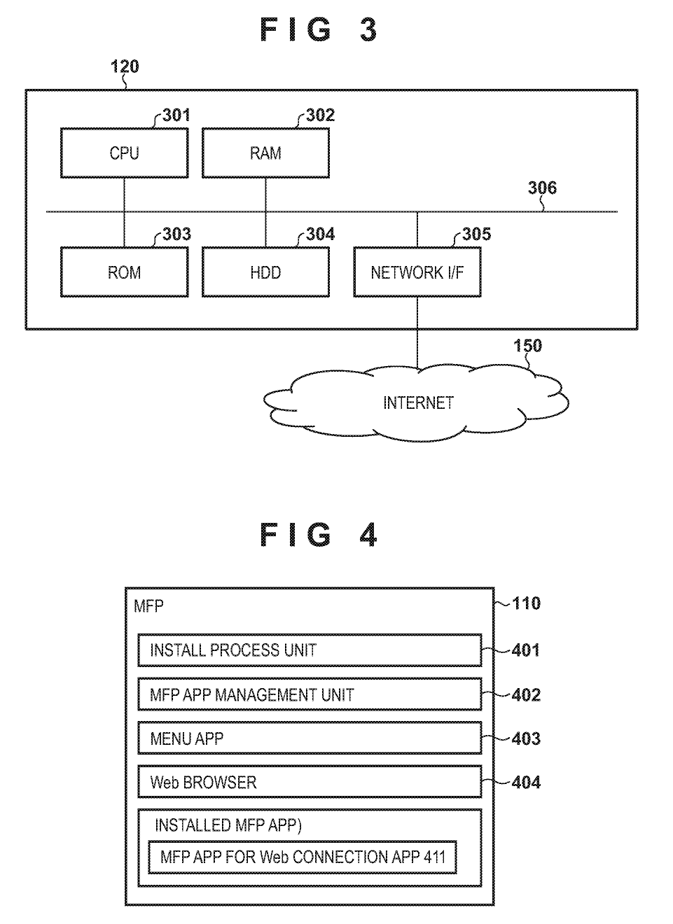

FIG. 3 is a block diagram for describing a hardware configuration of the Web application server 120 according to the embodiment. The Web application server 120 has a CPU 301, a RAM 302, a ROM 303, a hard disk drive (HDD) 304, and a network I/F 305, and these are connected so as to be able to communicate with each other via a system bus 306. The ROM 303 stores a boot program, and the CPU 301, when power is turned on, reads the boot program, and loads an OS, control programs, and the like which are installed in the HDD 304 into the RAM 302. Then, the CPU 301, by executing a program loaded into the RAM 302, realizes a function of the Web application server 120. Also, the CPU 301 communicates with another apparatus on a network connected via the network I/F 305. Note that the Web application server 130 also has a similar configuration.

MFP and Web App Server Software Modules

FIG. 4 is a view illustrating a software module configuration of the MFP 110 according to the embodiment. The software modules are stored in the HDD 204 of the MFP 110 and when executed are loaded into the RAM 203 and executed by the CPU 201.

An install process unit 401 controls installation of MFP apps. The install process unit 401 is connected to the PC 140 via the network I/F 206, and executes installation of an MFP app upon instruction from the PC 140.

In FIG. 4, it is assumed that an APP 411 which is an MFP app for Web connection (also referred to as an MFP application for Web connection) as an example of an embodiment is installed on the MFP 110. When the MFP app for Web connection is installed on the MFP 110, an ID for uniquely identifying the MFP app (hereinafter, MFP app ID) is registered in an MFP app management unit 402.

A menu app 403 is a program that displays a menu, and in accordance with selection of a function by a user from the menu, executes the selected function. The menu app 403, in addition to a print function and a copy function that the multi function peripheral provides independently, displays a menu item for selecting a function that is provided by an MFP app such as an MFP app for Web connection by using a symbol such as a button, for example.

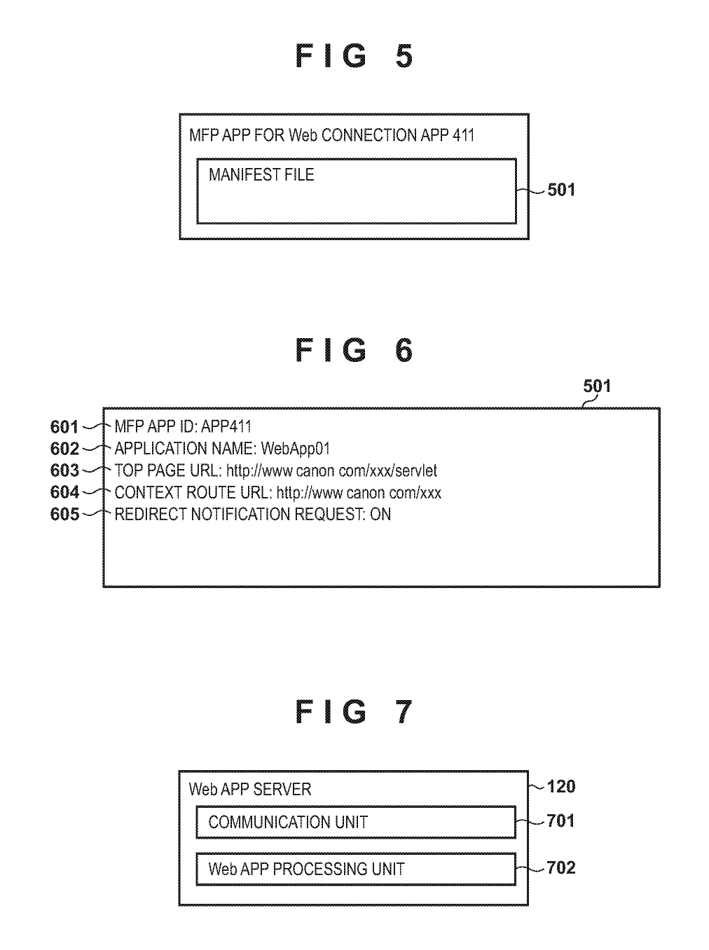

The MFP app for Web connection is an app for executing, from the MFP 110, a function that a Web app disposed on a Web app server provides. The MFP app for Web connection connects to a Web app by using a Web browser 404, and executes, from the MFP 110, a function that the Web app provides. Details of the MFP app for Web connection are described later in FIG. 5. Note that the number and types of MFP apps installed on an MFP depend on the MFP.

FIG. 5 is a view illustrating a configuration of software modules of an MFP app for Web connection according to the embodiment. The MFP app for Web connection holds in a manifest file 501 setting information necessary for each Web app. Specifically, one MFP app for Web connection is needed for every Web app. An MFP app for Web connection that corresponds to the Web app to use is installed on the MFP 110. In the case where a plurality of Web apps are to be used, a plurality of MFP apps for Web connection are installed on the MFP 110. In such a case, the plurality of MFP apps for Web connection end up being used sharing one Web browser 404. The manifest file 501 is a file in which base information of the MFP app and information for connecting to a Web app are described.

In FIG. 6 an example of a manifest file according to an embodiment is illustrated. In the manifest file 501, an MFP app ID 601, an application name 602, a Web application URL 603, a context route URL 604, and a redirect notification request 605 are defined. The MFP app ID 601 is an ID that is the same as what is being managed by the MFP app management unit 402. The application name 602 represents the title of the MFP app. The Web application URL 603, the context route URL 604, and the redirect notification request 605 are information specific to the MFP app for Web connection. The redirect notification request 605 may be a flag that takes the value of on or off, for example.

The Web application URL 603 represents a URL of a top page of the Web app. The context URL 604 represents a top path of the Web app, and is configured to be a URL for permitting execution of the function when a function of the MFP (scan, print, or the like) is executed from the Web app connected to by the MFP app for Web connection. For example, in a case where “http://www.canoon.com/xxx” is set to the context URL 604, configuration is such that the functions of the MFP cannot be executed from the Web page at a URL such as “http://www.canoon.com/yyy”. However, configuration is such that it is possible to execute the functions of the MFP from the Web page of a URL that is the same up to the top path, as with “http://www.canoon.com/xxx/yyy”. The redirect notification request 605 is a flag for indicating whether or not to make a notification of a redirect source URL, a redirect destination URL, a redirect code, and a redirect connection result to an MFP app for Web connection from the Web browser 404 when a redirect of the Web app from one Web app server (120) to another Web app server (130) occurs. Note that configuration may be such that a notification is performed when the flag is on and no notification is performed when it is off.

Also, what is different between individual MFP apps for Web connection is the definition in the manifest file 501, and other software modules are the same for all MFP apps for Web connection. Specifically, if a software module is re-used, it is possible to generate an MFP app for Web connection simply by defining information related to the Web app in the manifest file 501. For example, when information related to the Web app is inputted, it is possible to easily generate an MFP app for Web connection by preparing a tool for outputting the MFP app for Web connection.

FIG. 7 is a view illustrating a configuration of software modules of the Web application server 120 according to the embodiment. These software modules are stored in the HDD 304 of the Web application server 120, and the functions of these software modules are accomplished by loading them into the RAM 302 upon execution, and executing them by the CPU 301. The same is true for the Web application server 130.

A communication unit 701 communicates with an external apparatus via a network, receives requests and makes responses. A Web app processing unit 702, in response to a request from the MFP 110 according to the HTTP protocol, generates HTML content that is displayed by the Web browser 404 of the MFP 110, and generates content for operating the MFP 110.

MFP App Installation

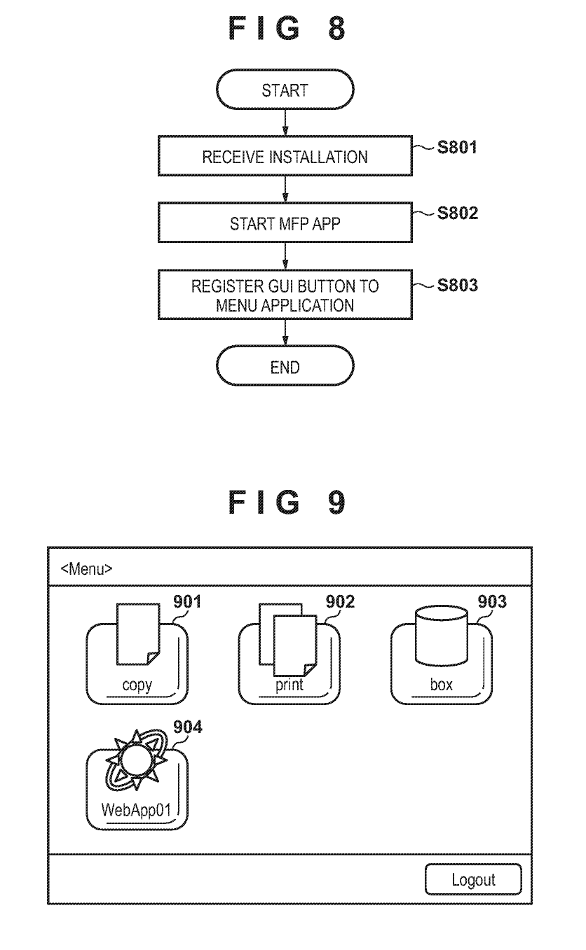

FIG. 8 is a flowchart for describing MFP app installation processing that the MFP 110 performs. Each step of the flowchart of FIG. 8 is executed by the CPU 201 reading into the RAM 203, analyzing, and executing a program that is stored in the HDD 204 of the MFP 110.

First, the install process unit 401 receives an MFP app as an install instruction from the PC 140 (step S801).

Next, the install process unit 401 saves the MFP app in the HDD 204. Continuing on, the install process unit 401 reads the MFP app that was saved in the HDD 204 into the RAM 203 and starts it (step S802). The started MFP app registers a GUI button for calling the MFP app to the menu app (step S803).

FIG. 9 is a view illustrating an example of a GUI that is displayed on the operating unit 111 when, in a state in which the MFP app for Web connection APP 411 is installed in the MFP 110 according to the embodiment, the menu app 403 of the MFP 110 is called. GUI buttons 901, 902, and 903 are GUI buttons for calling applications that are comprised in the MFP 110 from the beginning.

A GUI button 904 is a GUI button for calling the MFP app for Web connection APP 411. As illustrated in FIG. 9, the menu app 403 displays a GUI button without distinguishing an MFP app type.

Use of Web App from MFP

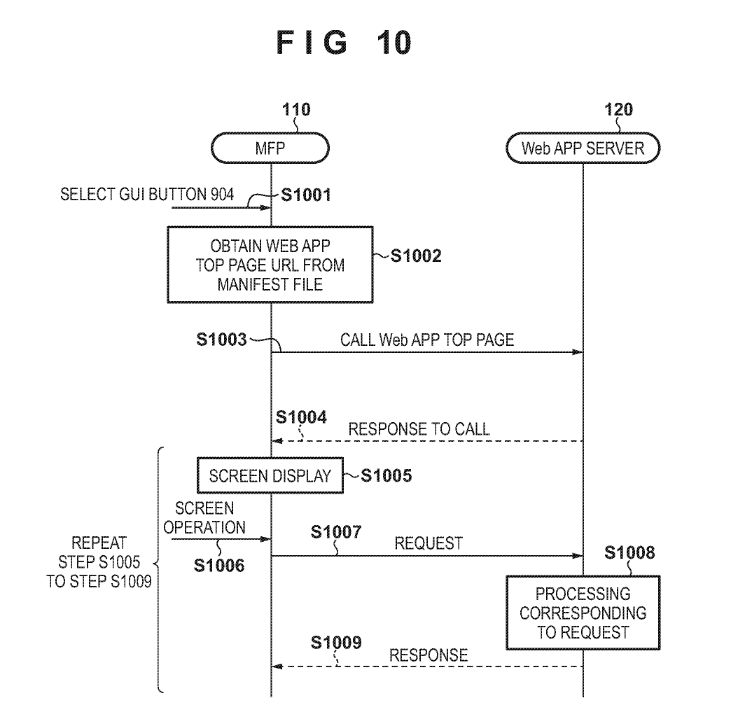

FIG. 10 is a sequence diagram that illustrates a flow of a sequence of processes for when a Web app is used from the MFP 110. Here, as an example, processing in a case where the GUI button 904 displayed on the menu app 403 is selected by a user is described.

First, when the menu app 403 of the MFP 110 receives a press of the GUI button 904 by the user, it calls (step S1001) the MFP app for Web connection APP 411 corresponding to the GUI button 904. The called MFP app for Web connection APP 411 obtains (step S1002) the top page URL of the Web app defined in the manifest file 501, and calls (step S1003) the top page of the Web app.

When the call is received, the Web application server 120 makes a response (step S1004) to the call to the MFP 110 (the Web browser 404). The Web application server 120 responds with HTML content for configuring a screen needed for the next operation.

The Web browser 404 renders the received HTML, and displays (step S1005) the screen on the operating unit 111. Next, when the Web browser 404 receives (step S1006) a screen operation instruction by the user, it transmits a corresponding request to the Web application server 120 by the HTTP protocol (step S1007).

The Web application server 120, after receiving the request, performs processing corresponding to the request (step S1008), and based on the processing result, responds to the MFP 110 (the Web browser 404) with HTML content for configuring the next screen (step S1009). Thereafter, Web app processing and screen transitions are realized by repeating step S1005 to step S1009.

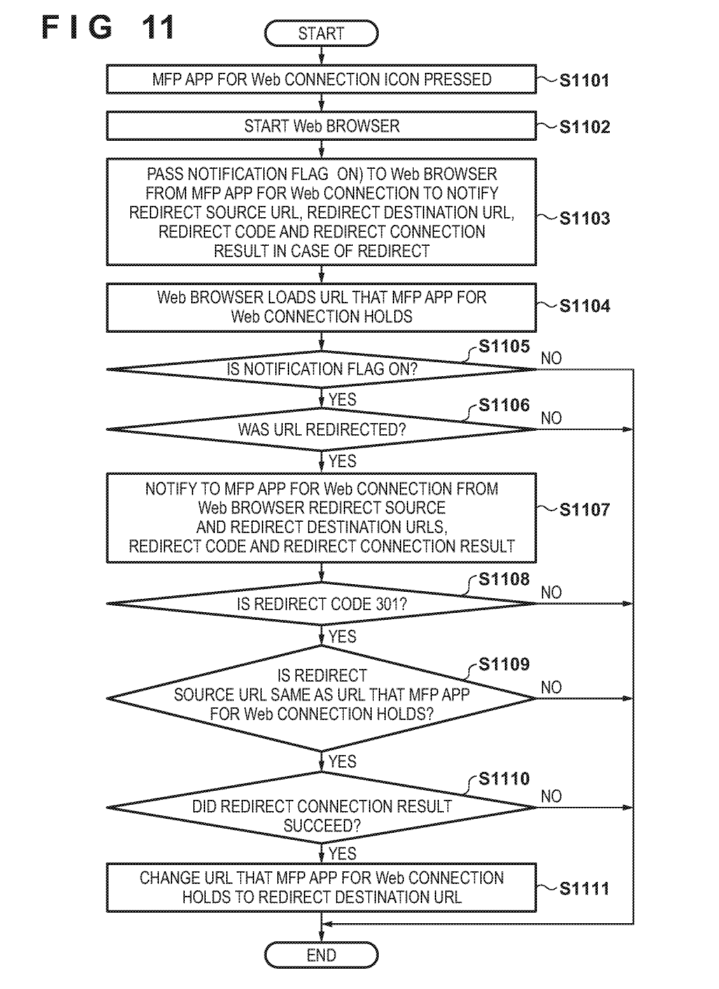

FIG. 11 is a flowchart for describing processing in a case in which a Web page redirect occurs when the MFP app for Web connection calls the top page of the Web app. Each step of the flowchart of FIG. 11 is executed by the CPU 201 reading into the RAM 203, analyzing, and executing a program that is stored in the HDD 204 of the MFP 110. In this procedure, step S1104-step S1107 are executed by the Web browser, and others are executed by the MFP app for Web connection which is triggered by the UI. Note that there are cases when the content access destination (URL or the like) of the Web app or the like is changed due to the Web app server being updated or the like, a redirect from a URL prior to the change to a URL after the change is performed over a fixed period thereafter, for example, and the user is thereby guided to the content whose URL was changed. Web page redirection in the present example is performed in a case where there is such a URL change.

When the GUI button 904 corresponding to the MFP app for Web connection is pressed by the user (step S1101), the MFP app for Web connection APP 411 starts the Web browser 404 (step S1102).

Next, in the later-described processing (step S1104), in a case where a Web page redirection occurs, the MFP app for Web connection passes (step S1103) to the Web browser 404 a notification flag for notifying to the MFP app for Web connection from the Web browser 404 a redirect source URL, a redirect destination URL, a redirect code (a predefined HTTP status code), and a redirect connection result. Note that it is possible to set the notification flag on and off, and configuration is such that in a case of setting it to be on, it is possible to receive a notification from the Web browser 404, and in a case of setting it to off, notification from the Web browser 404 is not received.

Next, the Web browser 404 loads (step S1104) a Web page corresponding to the top page URL 603 recited in the manifest file 501 that the MFP app for Web connection holds. At that time, the Web browser 404, in a case where a redirect response is received from the Web application server 120, accesses the redirect destination, and loads content such as a Web page or the like therefrom.

The Web browser 404, after the Web page is loaded, determines (step S1105) whether the notification flag passed from the MFP app for Web connection in previously described processing (step S1103) is on. In the case where the result of the determination is that it is on, step S1106 is advanced to, and when it is off the processing is ended.

Next, when the Web browser 404 loads a Web page in the previously described processing (step S1104), the Web browser 404 determines (step S1106) whether or not a Web page of another URL was connected to in a redirect. Since the redirect is performed based on a response from the Web application server 120, it is possible to perform the determination of step S1106 based on the HTTP response corresponding to the original HTTP request. Note that in the case of a redirect connection, information that indicates whether or not it was possible to connect to the Web app server of the redirect destination successfully (redirect connection result) is held in the Web browser 404. It is assumed that information that either the connection succeeded or the connection failed is held in the redirect connection result. Also, the redirect connection is a function in which, for example, when the Web browser 404 loads a Web app (a Web page) that operates on the Web application server 120, a transfer to a Web app (Web page) that runs on the Web application server 130 is automatically performed in accordance with a setting of the Web application server 120. In a case where the result of the determination as to whether or not a redirection connection was made is that a redirect connection was made, step S1107 is advanced to, and if a redirect connection was not performed, the processing is ended.

Next, in the case where in step S1106 it is determined that a redirect connection was made, the redirect source URL, the redirect destination URL, the redirect code, and the redirect connection result are notified (step S1107) to the MFP app for Web connection from the Web browser 404.

Next, the MFP app for Web connection determines (step S1108) whether the value of the redirect code notified from the Web browser 404 is 301. In the case where the result of the determination is that the redirect code is 301, step S1109 is advanced to, and in the case where the redirect code is other than 301, the processing is ended. Note that typically the redirect code 301 represents that the Web page URL was completely transferred to a new URL (non-transitorily or permanently). Conversely, a redirect code other than 301 indicates a temporary URL change. Accordingly, in the case where the redirect code is 301, the MFP app for Web connection can determine that there will be no operational problem even if the URL that the MFP app for Web connection holds is changed, and later described step S1109 is advanced to. Of course the value 301 is only one example, and if the code indicates a non-transitory URL move, the value may be other than 301. Meanwhile, a redirect code other than a value (such as 301) that indicates a non-transitory URL move represents a temporary transition to another URL. Accordingly, there is the possibility that if the URL that the MFP app for Web connection holds is changed, in the future when the URL is returned to the redirect source URL, connection to the Web page will cease to be possible. Accordingly, in such a case, the processing is ended without changing the URL that the MFP app for Web connection holds.

Next, the MFP app for Web connection determines (step S1109) whether or not the URL of the redirect source notified from the Web browser 404 and the top page URL 603 recited in the manifest file 501 of the MFP app for Web connection match. In the case where the result of the determination is that the URLs match, step S1110 is advanced to, and when they do not match the processing is ended.

Next, the MFP app for Web connection determines (step S1110) whether the redirect connection result notified from the Web browser 404 is success. In the case where the result of the determination is success, step S1111 is advanced to, and when it is failure the processing is ended.

In step S1111, the MFP app for Web connection changes (replaces the value) (step S1111) the top page URL 603 recited in the manifest file 501 to the URL of the redirect destination notified from the Web browser 404. Note that the context URL 604 recited in the manifest file 501 may be changed (have its value replaced) to the redirect destination URL notified from the Web browser 404 at this timing. With this, it becomes possible to execute a function (scan, print, or the like) of the MFP from the Web app (the URL after the redirect) connected to from the MFP app for Web connection.

Web Page Redirect

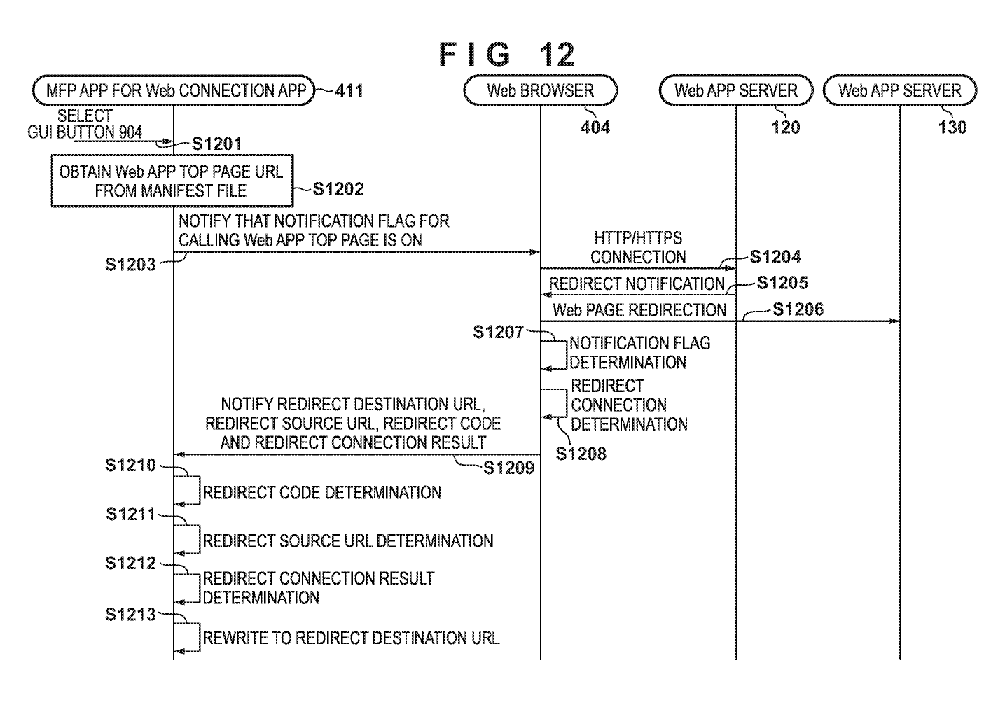

FIG. 12 is a sequence diagram for describing processing in a case in which a Web page redirect occurs when the MFP app for Web connection calls the top page of the Web app. Here, as an example, processing in a case where the GUI button 904 displayed on the menu app 403 is selected by a user is described.

First, when the menu app 403 of the MFP 110 receives a press of the GUI button 904 by the user, it calls the MFP app for Web connection APP 411 corresponding to the GUI button 904 (step S1201).

The called MFP app for Web connection APP 411 obtains the top page URL of the Web app defined in the manifest file 501 (step S1202). Based on the obtained URL, the top page of the Web app is called, and at this timing, the notification flag is notified (step S1203) to the Web browser 404. Note that in FIG. 12 it is assumed that the notification flag is passed as on.

The Web browser 404, after receiving the call, makes an HTTP or HTTPS connection (step S1204) to the Web application server 120. Note that the Web application server 120 of FIG. 12 makes a setting to redirect to a Web page that operates on the Web application server 130.

The redirect command notification is performed (step S1205) in relation to the Web browser 404 by the previously described setting of the Web application server 120.

The Web browser 404, after receiving a redirect connection command performs (step S1206) a connection to redirect to the Web page to the Web application server 130. Note that at this timing, the Web browser 404 holds, as a redirect connection result, whether successful connection to the redirect connection destination was possible or whether the connection failed. Furthermore, it is assumed that in FIG. 12 the redirect connection destination was connected to successfully.

The Web browser 404 determines (step S1207) whether or not the notification flag received from the MFP app for Web connection APP 411 in step S1203 is on. In the case where the result of the determination is that it is on, the later described processing of step S1208 is performed, and when it is off the processing is ended.

The Web browser 404 determines (step S1208) whether or not a redirect notification was received in step S1205. In a case where a redirect notification was received, the processing of step S1209 is performed, and in the case where a redirect notification was not received, the processing is ended.

In step S1208, in the case where a redirect notification is received, a redirect destination URL, a redirect source URL, a redirect code, and a redirect connection result are notified (step S1209) from the Web browser 404 to the MFP app for Web connection APP 411.

The MFP app for Web connection APP 411, after receiving the notification, determines (step S1210) whether the redirect code is 301. In the case where the result of the determination is that the redirect code is 301, the processing of step S1211 is performed, and in the case where the redirect code is other than 301, the processing is ended.

In step S1210, in the case where the redirect code is 301, it is determined (step S1211) whether or not the redirect source URL and the top page URL 603 described in the manifest file 501 match. In the case where the result of the determination is that the URLs match, the processing of step S1212 is performed, and when they do not match the processing is ended.

In the case where the URLs match in step S1211, it is determined (step S1212) whether or not the redirect connection result is success. In the case where the result of the determination is success, the top page URL 603 recited in the manifest file 501 is changed (value replaced) (step S1213) to the redirect destination URL notified from the Web browser 404. Note that the context URL 604 recited in the manifest file 501 may be changed (replaced) to the redirect destination URL notified from the Web browser 404 at this timing. In the case where the result of the determination is failure, the processing is ended.

By the foregoing procedure, even in the case where an access destination to the Web app is changed, it is possible to update the access destination associated with the MFP app for Web connection without manual intervention. Accordingly, it is possible to reduce workload and update the access destination accurately.

### Second Embodiment

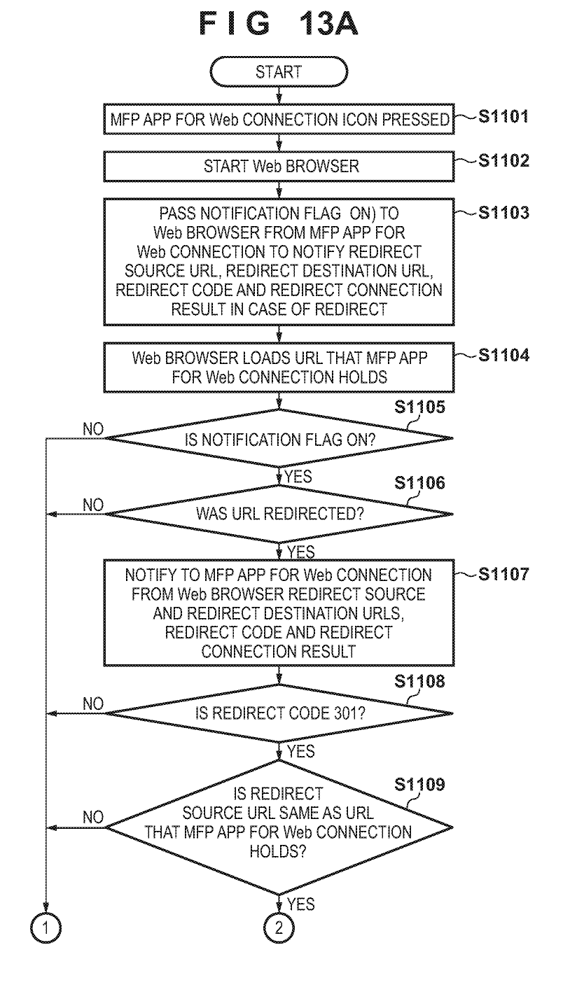

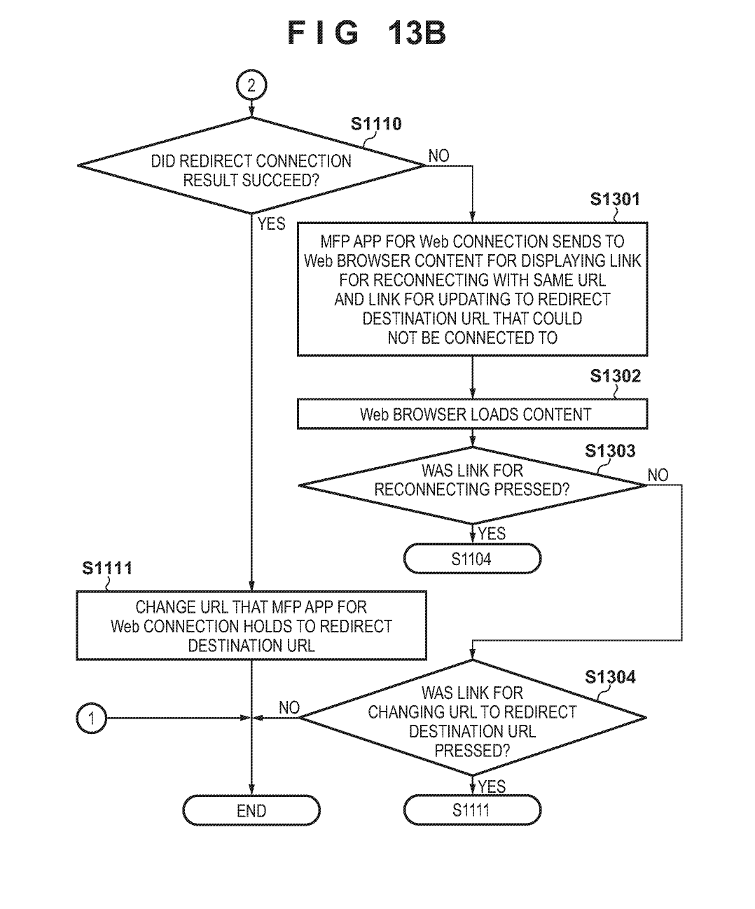

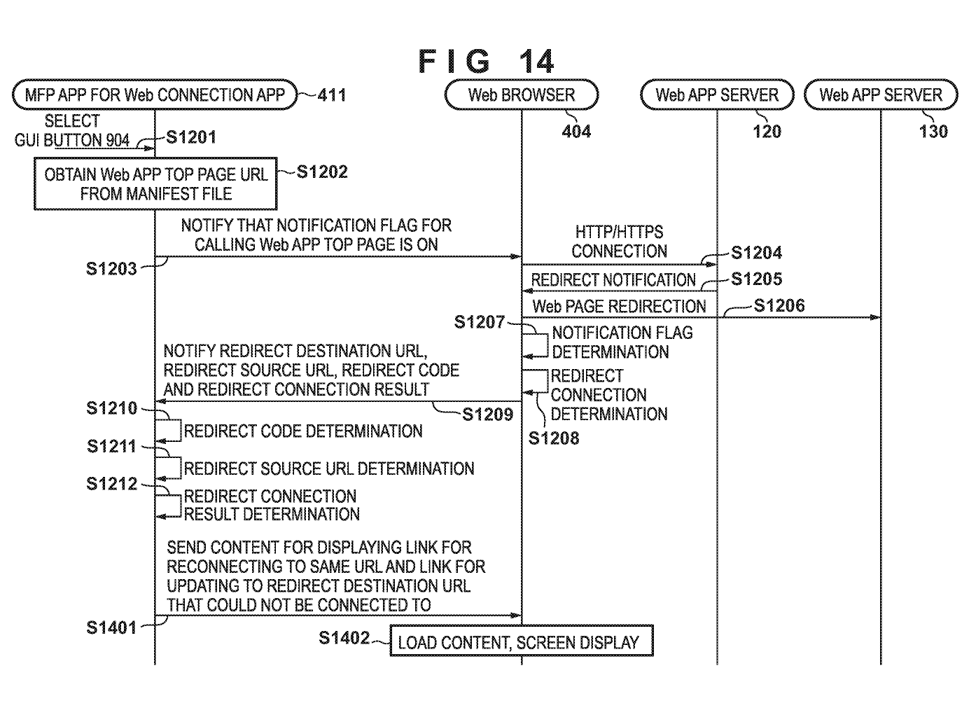

FIGS. 13A, 13B and FIG. 14 are flowcharts and a sequence diagram for describing processing in a case where, when the MFP app for Web connection calls the top page of the Web app, a Web page redirect occurs and the connection to the redirect destination fails. Note that the processing from step S1101 to step S1111 of FIGS. 13A and 13B is the same as the processing from step S1101 to step S1111 of FIG. 11. Also, the processing from step S1201 to step S1212 of FIG. 14 is the same as the processing from step S1201 to step S1212 of FIG. 12.

In step S1110 described previously in the description of FIG. 11, in a case where the redirect connection result fails, content for causing a link (for example, the GUI button or the like) for reconnecting (or re-accessing) and a link for updating the URL that the MFP app for Web connection holds to the redirect destination URL to be displayed is sent (step S1301, step S1401) from the MFP app for Web connection to the Web browser.

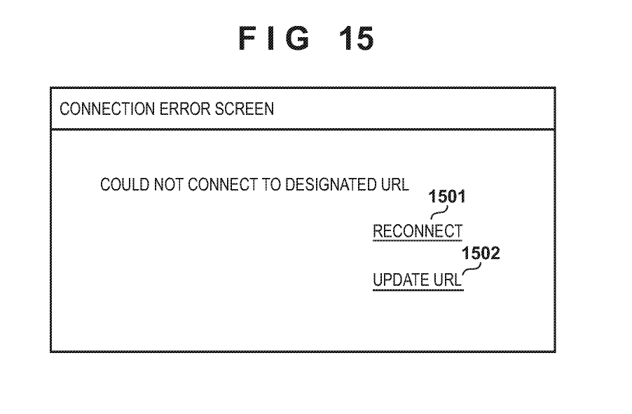

The Web browser loads content received from the MFP app for Web connection as a Web page and displays it (step S1302, step S1402). For example, it is assumed that a connection error screen as in FIG. 15 is displayed. In a case where the link 1501 for reconnection is pressed (step S1303) in the connection error screen, the processing from step S1104 is performed again, and in a case where the link 1502 for updating the URL is pressed (step S1304), the processing of step S1111 is performed. The link 1502 for updating the URL is for updating the URL in advance assuming that network settings will be fixed in the future and it will become possible to successfully connect to the redirect destination. In this way, a user interface such as FIG. 15 is displayed, and it is possible for the user to select either to re-access the original URL or to update the access destination URL in accordance with the redirect destination URL.

By virtue of the second embodiment, in the case where the connection to the redirect destination Web app failed, it is possible to select whether to try to re-connect or to update the URL associated with the MFP app for Web connection by the redirect destination URL.

By the procedure described in the first and second embodiments above, it becomes possible to automatically update the URL for connecting to the Web page that the MFP app for Web connection holds to the redirect destination URL when a Web page redirect from the Web app server (120) to the Web app server (130) occurs.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-140283, filed Jul. 19, 2017, which is hereby incorporated by reference herein in its entirety.

What is claimed is:

1. An information processing apparatus that has a Web browser and a connecting unit for connecting to a server that provides a Web application, the information processing apparatus comprising:
at least one processor;
and at least one memory in which a program is stored, wherein
by the processor executing the program, the information processing apparatus is caused to function as
an access unit that, in accordance with an instruction, accesses via the Web browser a registered access destination corresponding to the Web application; and
an update unit that, in a case where it is notified from the Web browser that the registered access destination is redirected to a new access destination, updates the registered access destination with the new access destination.

2. The information processing apparatus according to claim 1, wherein the access unit accesses the registered access destination by executing an application for Web connection.

3. The information processing apparatus according to claim 2, wherein the registered access destination is registered to a manifest file of the application for Web connection.

4. The information processing apparatus according to claim 1, wherein in the notification that the registered access destination was redirected to the new access destination from the Web browser, a redirect source access destination, a redirect destination access destination, and a redirect code indicating whether or not a non-transitory change of access destination was made are included, and
the update unit, in a case where the redirect code indicates that a non-transitory change of access destination was made, updates the registered access destination with the new access destination.

5. The information processing apparatus according to claim 1, wherein by the processor executing the program, the information processing apparatus is further caused to function as
a unit that transfers to the Web browser information indicating whether or not to make a notification that an access destination was redirected.

6. The information processing apparatus according to claim 1, wherein
in a case where it is notified from the Web browser that the registered access destination was redirected and access to the new access destination failed, the update unit displays a user interface that enables a user to select whether to re-access the registered access destination or to update the registered access destination with the new access destination.

7. The information processing apparatus according to claim 6, wherein
the update unit updates the registered access destination with the new access destination in accordance with an operation for updating the registered access destination with the new access destination on the user interface.

8. A non-transitory computer readable medium storing a program, wherein when the program is executed by a computer that has a Web browser and a connecting unit for connecting to a server that provides a Web application, the computer is caused to function as an access unit that, in accordance with an instruction, accesses via the Web browser a registered access destination corresponding to the Web application; and
an update unit that, in a case where it is notified from the Web browser that the registered access destination is redirected to a new access destination, updates the registered access destination with the new access destination.

9. A method of controlling an information processing apparatus that has a connecting unit for connecting to a server that provides a Web application and a Web browser, the method comprising:
an access unit of the information processing apparatus, in accordance with an instruction, accessing via the Web browser a registered access destination corresponding to the Web application; and
an update unit of the information processing apparatus, in a case where it is notified from the Web browser that the registered access destination is redirected to a new access destination, updating the registered access destination with the new access destination.

10. The method of controlling the information processing apparatus according to claim 9, wherein
the accessing accesses the registered access destination by executing an application for Web connection.

11. The method of controlling the information processing apparatus according to claim 10, wherein
the registered access destination is registered to a manifest file of the application for Web connection.

12. The method of controlling the information processing apparatus according to claim 9, wherein
in the notification that the registered access destination was redirected to the new access destination from the Web browser, a redirect source access destination, a redirect destination access destination, and a redirect code indicating whether or not a non-transitory change of access destination was made are included, and
the updating, in a case where the redirect code indicates that a non-transitory change of access destination was made, updates the registered access destination with the new access destination.

13. The method of controlling the information processing apparatus according to claim 9, further comprising
transferring to the Web browser information indicating whether or not to make a notification that an access destination was redirected.

14. The method of controlling the information processing apparatus according to claim 9, wherein
in a case where it is notified from the Web browser that the registered access destination was redirected and access to the new access destination failed, the updating displays a user interface that enables a user to select whether to re-access the registered access destination or to update the registered access destination with the new access destination.

15. The method of controlling the information processing apparatus according to claim 14, wherein
the updating updates the registered access destination with the new access destination in accordance with an operation for updating the registered access destination with the new access destination on the user interface.
